(19) United States
(12) Patent Application Publication
(10) Pub. No.: US 2008/0178988 A1
(43) Pub. Date: Jul. 31, 2008

(54) METHOD OF LABELLING OF FROZEN OBJECTS

(76) Inventor: Gourgen AMBARTSOUMIAN, Laval (CA)

Correspondence Address: OGILVY RENAULT LLP, 1981 MCGILL COLLEGE AVENUE, SUITE 1600, MONTREAL, QC, H3A2Y3, omitted

(21) Appl. No.: 11/945,322

(22) Filed: Nov. 27, 2007

Related U.S. Application Data
(60) Provisional application No. 60/867,215, filed on Nov. 27, 2006.

(51) Int. Cl. B65C 9/24; B29C 65/02; B32B 37/06

(52) U.S. Cl. 156/80; 156/499; 156/387

(57) ABSTRACT

A method of labelling vials and containers for storing in freezing or cryogenic environment. More specifically, a method for labelling of vials and other containers which have a low surface temperature such as found in vials or containers freshly removed from a freezing or cryogenic environment.

### CROSS REFERENCE TO RELATED APPLICATIONS

This patent application claims priority on U.S. Provisional Patent Applications No. 60/867,215, filed on Nov. 27, 2006.

### FIELD OF THE INVENTION

The present invention relates to a method of labelling vials and containers for storing in freezing or cryogenic environment. More specifically, it relates to labelling of vials and other containers which have a low surface temperature such as found in vials or containers freshly removed from a freezing or cryogenic environment.

### BACKGROUND OF THE INVENTION

It is routine practice in biotechnology and biomedical laboratories to store cell lines, DNA libraries, tissues, viruses, bacteria, fungi and other biological specimens and biochemical agents in cryogenic and freezing environments for the purpose of better preservation for extended periods of time (up to 15-20 years or more). In the biomedical and biotechnology fields, proper and secure labelling and identification of containers and objects carrying these types of biological substances are pivotal for daily research and clinical operations. Other industries also require labelling of frozen surfaces such as shelves and objects in commercial freezer.

Presently there are cryogenic pressure-sensitive labels available which can be printed with thermal-transfer printers and are offered by a number of companies (for example, GA International Inc. and others). Thermoplastic labels for cryogenic storage containers which can be inscribed by various writing instruments and/or printed in laser printers are offered by GA International Inc., and others and are described, for example, in U.S. Pat. No. 5,836,618 ('618) or No. 7,108,909 ('909). One of the issues associated with cryogenic pressure-sensitive labels is that they are not effective when applied onto frozen surfaces, for example, vials, boxes, cans or other containers. It is a well known fact that pressure-sensitive labels do not adhere well to cold surfaces. Cryogenic labels described in '618 or '909, such as 3M label material 7604FP in manufacturer's datasheet, specify that “Low temperature surfaces, below 50° F. (10° C.), cause adhesive to become firm and will not allow to develop intimate adhesive contact”. Even the efforts to wipe off the condensation prior applying the label do not allow proper label adhesion. As a result, the labels do not adhere to frozen container and detach immediately or shortly after the adhesion. As for permanent markers used to identify boxes, the wet surface, ice build-up and cold temperature in combination or individually often do not allow the ink from permanent marker to flow easily and properly bond with the surface, which results fuzzy and non-homogeneous markings which very often can be wiped off.

### SUMMARY OF THE APPLICATION

It is therefore an aim of the present invention to provide an identification method that addresses issues associated with the prior art.

Therefore, in accordance with the present invention, there is provided a method of labelling frozen vials and containers with a preheated label. The term label can also mean tape.

Additionally, in accordance with the present invention, there is provided a label-dispensing device for heating the labels prior the application to a frozen vial or container.

### BRIEF DESCRIPTION OF THE DRAWINGS

FIG. 1 is a side view of a label dispensing device in accordance with an embodiment of the present invention.

### DESCRIPTION OF THE PREFERRED EMBODIMENTS

Very often it is required to label or relabel vials and other containers which are already stored in cryogenic or freezer environment such as liquid or vapour phase liquid nitrogen, freezer, dry ice, Alcohol-dry-ice bath and other low-temperature conditions when the container has a surface temperature around 0° C. or below, or even more preferably −15° C. or below, or even more preferably −70° C. or below, or even more preferably −80° C. or below and even more preferably −100° C. or below, or even more preferably −196° C. or below. For a long time, this problem has not been solved. The answer to the problem was discovered by increasing the temperature of the adhesive at the contact point with a frozen surface of the vial or other container. When an adhesive label is applied to a container there is a temperature equilibration taking place between the label and the container. When both are at room temperature, around 18-22° C., the temperature of the adhesive remains the same as the temperature of the containers surface which allows an adequate flow of the adhesive from the label to the container and adequate bonding. When the same label at room temperature is applied to a container following its removal from a freezing or cryogenic environment e.g., −70° C., the equilibration between temperatures on the contact will take place between the adhesive-coated label and the container. Since the mass of the container in most cases is significantly larger than the mass of the label, the equilibration will yield a significant temperature drop for the adhesive and the label whereas the temperature of the container will stay relatively the same. In the case when the vial or container is at room temperature, then the temperature of the adhesive is sufficient to support the adequate flow of the adhesive and appropriate bonding. But when the temperature of adhesive drops during the contact with the frozen container the adhesive gets hardened and consequently cannot flow and form an adequate bond. Based on the model developed, the solution was found by increasing the temperature of the adhesive label at the moment of application to the frozen vial or container such as preheating the label prior applying to the frozen container. Our tests showed that when the adhesive temperature is around 60-70° during the contact with frozen surface, the equilibration yields some brief increase of the temperature of the contact surface of the vial or container which is sufficient to permit for a very short time the adequate flow of the adhesive and its bonding with a vial or container. After the bonding is taken place, the temperature of the adhesive and the label components will drop but it will not affect the adhesion since the label is firmly bound to the container through the adhesive.

So, a theory is developed that adhesion of a label to a frozen surface can be enforced by a brief increase of the temperature at the contact point between the adhesive and container.

Based on the theory a new method of cryogenic labelling is developed involving the following steps:
1) Preheating the adhesive coated label or tape;
2) Dispensing or removing it from the release liner;
3) Removing the vial or container from a freezer;
4) Applying the preheated label or tape to the surface of a said vial or container;
5) Placing the vial or container into a freezer or cryogenic storage.

The above described steps can be in following sequence: 1,2,3,4,5, or 1,3,2,4,5, or 2,1,3,4,5, or 2,3,1,4,5 or 3,1,2,4,5 or 3,2,1,4,5.

Additional step of wiping off the condensation prior applying the label may be required in any of the sequences described.

As a preferred embodiment, the label comprises a thermoplastic facestock film. In another embodiment, the label comprises a vinyl or polyvinyl facestock including but not limited to polyvinyl chloride. In another embodiment, the label comprises a polyolefin facestock. In another embodiment, the label facestock comprises a woven material, cloth, nylon, paper, impregnated paper, thermoplastic, or any combination thereof.

The label facestock may comprise a topcoat for accepting the printing from laser (black-and-white or color) printer, ink-jet printer, thermal-transfer printer, direct-thermal printer, or from any combination thereof, or handwriting by using permanent ink marker, felt-tip marker, ballpoint pen, jell-based ink pen, pencil or combination thereof. In another embodiment, the facestock may not comprise a topcoat but still be capable accepting printing or handwriting from said printing or handwriting instruments.

The label comprises non-ionomer pressure-sensitive adhesive. As a preferred embodiment, the label comprises rubber adhesive. In another embodiment, the label comprises acrylic adhesive. In another embodiment, the label comprises hot-melt adhesive. In another embodiment, the label comprises any combination of non-ionomer pressure-sensitive adhesives.

As a preferred embodiment, the adhesive-coated labels are provided on a sheet comprising a liner. In another embodiment, the labels are provided on a roll or fanfold or a stripe comprising a liner.

As a preferred embodiment, the material is a adhesive-coated self-wound tape without a liner.

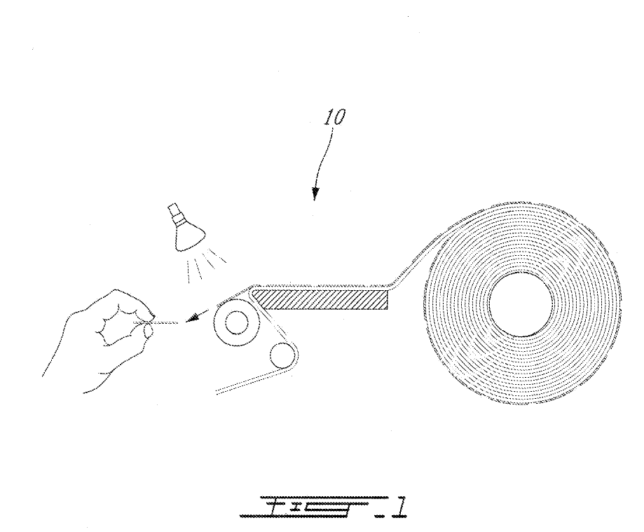

A crude label dispensing device (10) (see FIG. 1) has been developed containing a label dispenser with an attached metallic plate. As one option, the metallic plate has an electrical heater attached underneath the plate. In another option, the metallic plate has an infrared heating lamp underneath. The electrical heater or the infrared lamp is heating the plate which subsequently heats the label. The device can further comprises a support liner for aligning properly the heated labels. The invention covers any method used that will result heating the label for the purpose of adhering to frozen object. This includes any heat source or waves capable of generating heat intended for heating the label. Heating source is located or placed on, at, inside, within or around any part of the dispenser that can heat the label or tape. As a preferred embodiment the heat source is an electrical heater or heating element. As a preferred embodiment the heat source is a light source capable of generating heat. As a preferred embodiment, the light source can be an ordinary electrical light bulb, a halogen light or infrared light. As a preferred element the heat source is a hot air blowing device similar to hair drier.

The applicant conducted the following tests:

3 sets of 5 vials (1.5 ml polypropylene microtubes) were stored in dry ice (−78° C.) for 30 minutes. Preliminary 3 sets of 5 polyvinyl labels CL-3 (Cryogenic polyvinyl labels for laser printer sold by GA International Inc. since 2000) were cut to 1″×0.5″ size. First set of labels which were at room temperature were attempted to attach to the first set of frozen microtubes immediately after wiping off the condensation, but all the labels from first set detached immediately. The second set of labels was preheated up to 60-70° C. prior attaching to the microtubes. In the second set of microtubes, the condensation was wiped off as in the first set and all preheated labels adhered firmly to the vials and stayed attached after storing them back for at least 6 hours (time of observation) in dry ice. The third set of preheated labels were attempted to attach to microtubes without wiping off the condensation, but none of them adhered to the surface.

The same experiment was repeated with another cryogenic polyvinyl label for laser printer RCL-6 (Cryogenic polyvinyl labels for laser printer sold by GA International Inc. since 2002). The results were similar to CL-3 labels in set 1 and set 2. The set 3 of the RCL-6 preheated labels were able to adhere to microtubes even without wiping off the condensation, indicating that the adhesive in RCL-6 labels has a capability to adhere to wet surface.

1. Method of identification of vial or container or item freshly removed from a freezing or cryogenic environment comprising a preheated label for applying to the said container.

2. The method claim 1, wherein the label is preheated to a temperature between 30° C. and 100° C.

3. The method of claim 1, wherein the label comprises a polymer, thermoplastic film, paper, impregnated paper, woven material, cloth, nylon, foam, metal, ceramic, composite material or any combination thereof.

4. The method of claim 1, wherein the label further comprises an electronic component selected from the group consisting of an electronic circuit, a RFID antenna, a RFID tag and a RFID transmitter.

5. The method of claim 1, wherein the label is in a roll, sheet, fanfold, stripe or fragment form.

6. The method of claim 1, wherein the label is laminated with a layer film.

7. The method of claim 1, wherein the label comprises at least one facestock, one coat of adhesive or a coating of varnish.

8. The method of claim 7, wherein the facestock has a thickness of at least 0.01 millimeter.

9. The method of claim 7, wherein the adhesive is selected from the group consisting of acrylic, rubber, emulsion, hotmelt, solvent and water-based adhesive or any combination thereof.

10. The method of claim 1, wherein the label entirely or partly opaque, transparent, printed or tinted.

11. The method of claim 10, wherein said transparent part serves as a wrap-around to function as a lamination.

12. Label dispensing device containing a label or tape dispensing mechanism and a heat source.

13. The device of claim 12, further comprising a support liner.

14. The device of claim 12, wherein the heat source is a light source, an electrical heater, heating element or a hot air blowing device.

15. The device of claim 12, wherein the heat source is a separate unit from the device.

16. The device of claim 12, wherein the dispensing of the label is done manually, mechanically or electronically.

17. The device of claim 12, further comprising a printing device, a peeling device or a label applicator.

18. A kit comprising a lable dispensing device as defined in claim 12 and a heat source.

19. The kit of claim 18, further comprising a label or a peeler.
